(19) United States
(12) Patent Application Publication
(10) Pub. No.: US 2011/0032350 A1
(43) Pub. Date: Feb. 10, 2011

(54) ILLUMINATION DEVICE AND IMAGE ACQUISITION APPARATUS

(75) Inventors: Satoru KIKUCHI, Tokyo (JP); Hiroyoshi Kobayashi, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: OLYMPUS CORPORATION, Tokyo (JP)

(21) Appl. No.: 12/905,144

(22) Filed: Oct. 15, 2010

Related U.S. Application Data
(63) Continuation of application No. PCT/JP2009/057306, filed on Apr. 3, 2009.

(30) Foreign Application Priority Data
Apr. 18, 2008 (JP) 2008-109283

(51) Int. Cl. H04N 5/225; F21V 9/00; F21V 14/00; H04N 7/18; H04N 5/262

(52) U.S. Cl. 348/135; 362/231; 348/370; 348/345; 348/240.99; 348/E05.024; 348/E07.085; 348/E05.051

(57) ABSTRACT

An illumination device includes a first illumination section having a first light source which emits white light and a first optical system for applying, with a first directional characteristic, the white light emitted from the first light source, and a second illumination section having a second light source which emits light of a color different from the color of the light from the first light source, and a second optical system for applying the light emitted from the second light source with a second directional characteristic such that the light is applied to a second application area contained in and smaller than a first application area based on the first directional characteristic.

### CROSS REFERENCE TO RELATED APPLICATION

This application is a continuation application of PCT/JP2009/057306 filed on Apr. 3, 2009 and claims benefit of Japanese Application No. 2008-109283 filed in Japan on Apr. 18, 2008, the entire contents of which are incorporated herein by this reference.

### BACKGROUND OF INVENTION

1. Field of the Invention

The present invention relates to an illumination device and an image acquisition apparatus capable of applying white light and light of a color different from white.

2. Description of the Related Art

Illumination devices for applying illumination light to objects are being widely used in the field of observation and photographing of objects. A concrete example of such illumination devices is illumination devices used in the field of dentistry.

Conventionally, some of the dental illumination devices use fluorescent lamps of a particular color temperature (e.g., 5000 K°). Such a dental illumination device is used by a dentist or a dental technician in so-called shade taking for comparison and evaluation between a natural tooth and an artificial tooth.

For example, a dental illumination device more suitable for use in shade taking is described in Japanese Patent Application Laid-Open Publication No. 2003-7478. The dental illumination device described in this publication has a shade taking light using two or more types of light sources differing in emission color from each other (more specifically, three types of fluorescent lamps differing in color temperature). Further, in the publication, a technique including the provision of a blue light-emitting diode for enabling emission of a complementary color of the color of a tooth with a hue ranging from yellow to orange is described.

In Japanese Utility Model Registration No. 3084178, a shadowless lamp using a plurality of LEDs as a light source is described and a configuration of a plurality of LEDs which emit different wavelengths of light is also described.

Objects to be observed or photographed in dentistry include not only teeth with hues ranging from yellow to orange but also gums or the like with a red hue.

### SUMMARY OF THE INVENTION

An illumination device according to one aspect of the present invention includes a first illumination section having a first light source which emits white light and a first optical system for applying, with a first directional characteristic, the white light emitted from the first light source, and a second illumination section having a second light source which emits light of a color different from the color of the light from the first light source, and a second optical system for applying the light emitted from the second light source with a second directional characteristic such that the light is applied to a second application area contained in and smaller than a first application area based on the first directional characteristic.

An image acquisition apparatus according to another aspect of the present invention includes the illumination device according to the above-mentioned one aspect, and an image pickup apparatus for obtaining an image signal by picking up an image of an object illuminated with the illumination device.

### BRIEF DESCRIPTION OF THE DRAWINGS

FIG. 1 is a diagram showing a configuration of an image acquisition apparatus having an illumination device and an image pickup apparatus in Embodiment 1 of the present invention;

FIG. 2 is a diagram showing emission spectrums of a first light source and a second light source in Embodiment 1;

FIG. 3 is a diagram for explaining a method of determining the emission spectrum of the second light source in Embodiment 1;

FIG. 4 is a diagram showing an example of setting of the emission spectrum of the second light source outside a band of a reflection spectrum of a portion of an object other than a particular portion of the object in Embodiment 1;

FIG. 5 is a diagram showing an example of setting of the emission spectrum of the second light source in tooth observation in Embodiment 1;

FIG. 6 is a diagram showing an example of setting of the reflection spectrum of the second light source in Embodiment 1 when a band of a reflection spectrum of the particular portion of the object is on the longer-wavelength side than the band of the reflection spectrum of the portion other than the particular portion;

FIG. 7 is a diagram showing directional characteristics of a first illumination section and a second illumination section in Embodiment 1;

FIG. 8 is a diagram showing teeth and a gum as the object in Embodiment 1;

FIG. 9 is a diagram showing the state of a spot of illumination formed at the position of the object by the first illumination section and the second illumination section in Embodiment 1;

FIG. 10 is a diagram showing a state in which the teeth and the gum as the object are irradiated with spots of illumination by the first illumination section and the second illumination section in Embodiment 1;

FIG. 11 is a diagram showing a configuration of an image acquisition apparatus having an illumination device and an image pickup apparatus in Embodiment 2 of the present invention;

FIG. 12 is a diagram showing a state in which a second application area is positioned at a center of a first application area in Embodiment 2;

FIG. 13 is a diagram showing a state in which the second application area is positioned in an upper right portion of the first application area in Embodiment 2;

FIG. 14 is a diagram showing a state in which the second application area is positioned in a lower left portion of the first application area in Embodiment 2;

FIG. 15 is a diagram showing a configuration of an image acquisition apparatus having an illumination device and an image pickup apparatus in Embodiment 3 of the present invention;

FIG. 16 is a diagram schematically showing the states of directional characteristics of a first illumination section and a second illumination section in Embodiment 3 when an object is at a short distance from the illumination device;

FIG. 17 is a diagram schematically showing the states of the directional characteristics of the first illumination section and the second illumination section in Embodiment 3 when the object is at a medium distance from the illumination device;

FIG. 18 is a diagram schematically showing the states of the directional characteristics of the first illumination section and the second illumination section in Embodiment 3 when the object is at a long distance from the illumination device;

FIG. 19 is a diagram showing a configuration of an image acquisition apparatus having an illumination device and an image pickup apparatus in Embodiment 4 of the present invention;

FIG. 20 is a diagram showing the state of a color mixing region in Embodiment 4 when the intensity of emission from a first light source is increased while the intensity of emission from a second light source is reduced;

FIG. 21 is a diagram showing the state of the color mixing region in Embodiment 4 when the intensity of emission from the first light source is set to a medium level and the intensity of emission from the second light source is also set to a medium level;

FIG. 22 is a diagram showing the state of the color mixing region in Embodiment 4 when the intensity of emission from the first light source is reduced while the intensity of emission from the second light source is increased;

FIG. 23 is a diagram showing a configuration of an image acquisition apparatus having an illumination device and an image pickup apparatus in Embodiment 5 of the present invention;

FIG. 24 is a block diagram showing details of an image pickup unit in Embodiment 5; and

FIG. 25 is a block diagram showing a configuration of an image acquisition apparatus having an illumination device and an image pickup apparatus in Embodiment 6 of the present invention.

### DETAILED DESCRIPTION OF THE PREFERRED EMBODIMENT(S)

Embodiments of the present invention will be described with reference to the drawings.

### Embodiment 1

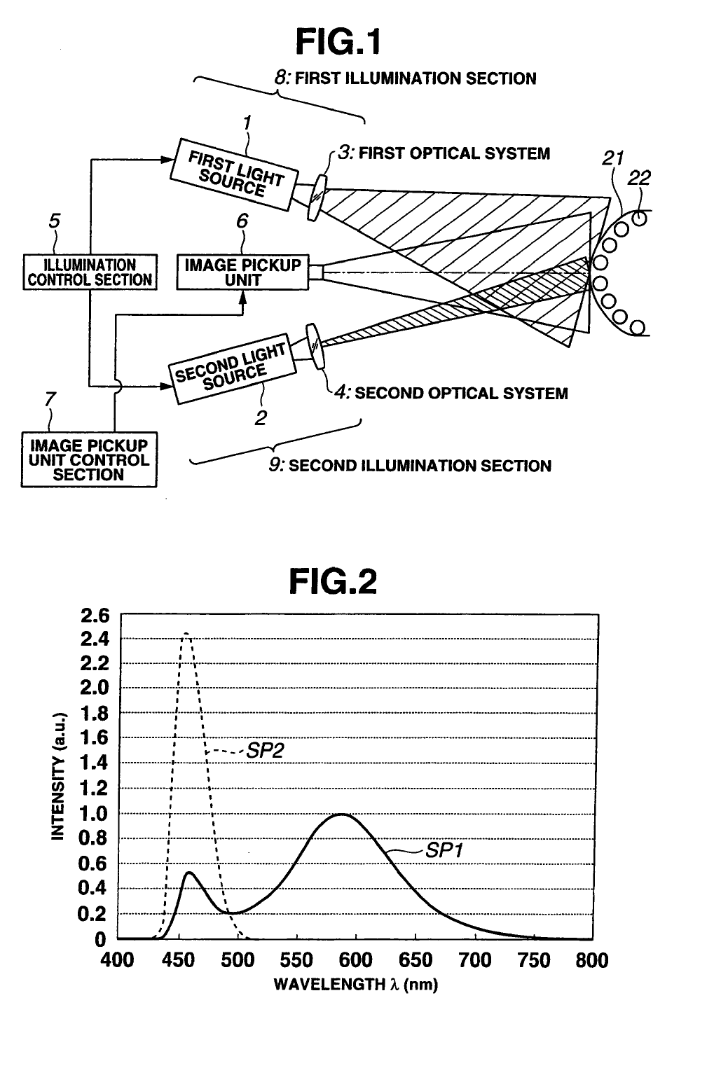

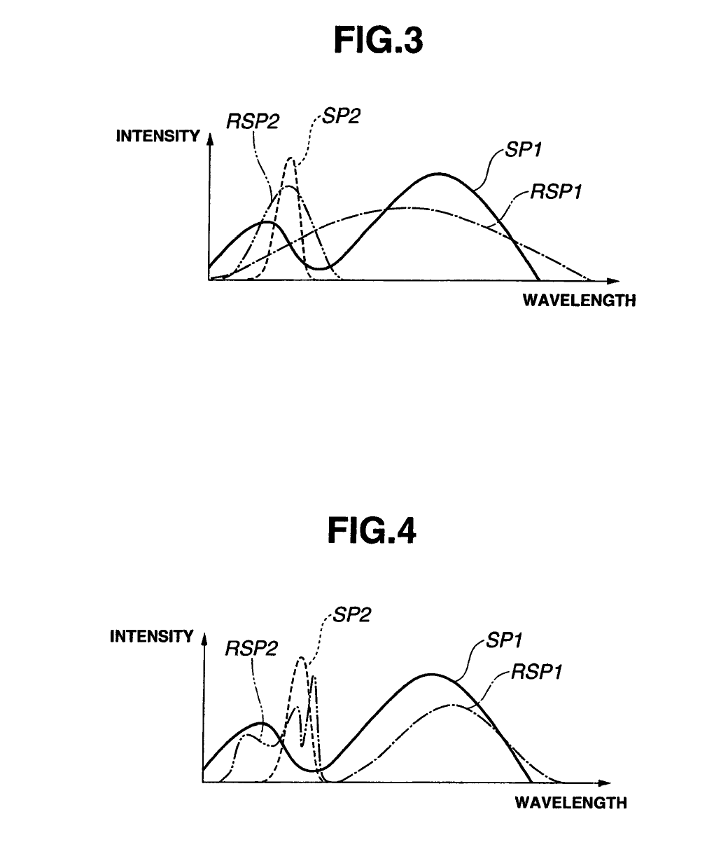

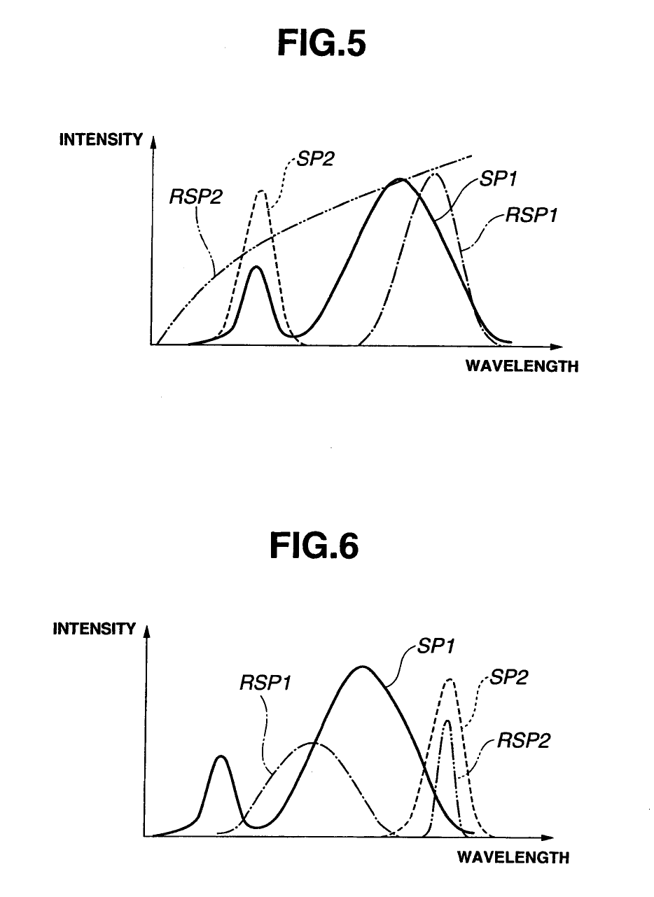

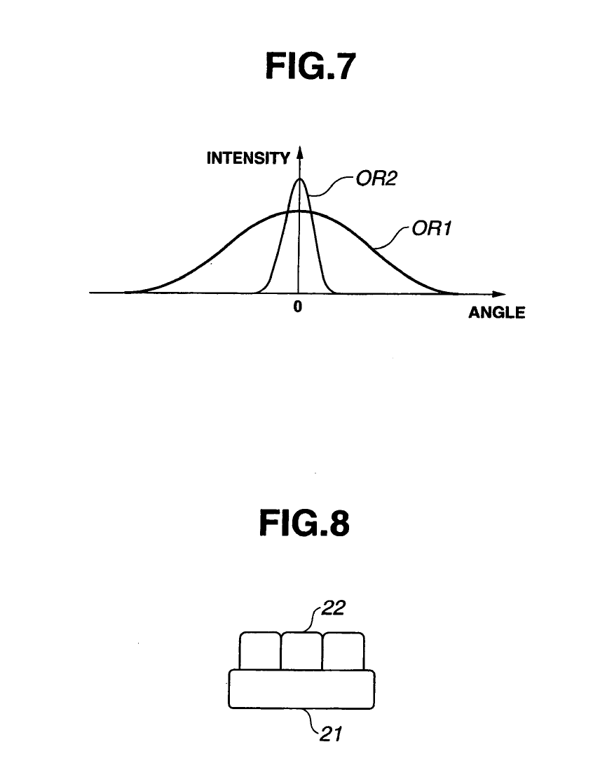

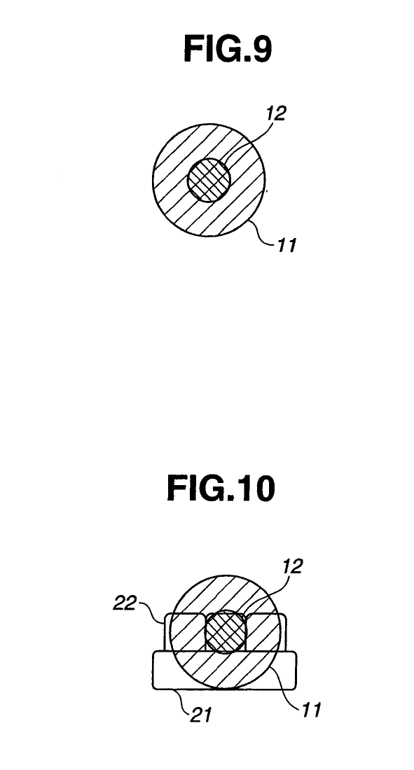

FIGS. 1 to 10 show Embodiment 1 of the present invention. FIG. 1 is a diagram showing a configuration of an image acquisition apparatus having an illumination device and an image pickup apparatus. FIG. 2 is a diagram showing emission spectrums of a first light source and a second light source. FIG. 3 is a diagram for explaining a method of determining the emission spectrum of the second light source. FIG. 4 is a diagram showing an example of setting of the emission spectrum of the second light source outside a band of a reflection spectrum of a portion of an object other than a particular portion of the object. FIG. 5 is a diagram showing an example of setting of the emission spectrum of the second light source in tooth observation. FIG. 6 is a diagram showing an example of setting of the reflection spectrum of the second light source when a band of a reflection spectrum of the particular portion of the object is on the longer-wavelength side than the band of the reflection spectrum of the portion other than the particular portion. FIG. 7 is a diagram showing directional characteristics of a first illumination section and a second illumination section. FIG. 8 is a diagram showing teeth and a gum as the object. FIG. 9 is a diagram showing the state of a spot of illumination formed at the position of the object by the first illumination section and the second illumination section. FIG. 10 is a diagram showing a state in which the teeth and the gum as the object are irradiated with spots of illumination by the first illumination section and the second illumination section.

The present embodiment is an embodiment relating to a dental illumination device for performing photographing by applying illumination light to teeth and a gum as an object and to an image acquisition apparatus having the illumination device.

As shown in FIG. 1, the image acquisition apparatus is configured by being provided with an illumination device and an image pickup apparatus.

The illumination device has a first illumination section 8 having a first light source 1 and a first optical system 3, a second illumination section 9 having a second light source 2 and a second optical system 4, and an illumination control section 5 for controlling the first illumination section 8 and the second illumination section 9.

The image pickup apparatus has an image pickup unit 6 for picking up a moving image or a still image of an object, and an image pickup unit control section 7 which controls the image pickup unit 6.

An object which is illuminated by the illumination device and whose image is picked up by the image pickup apparatus is constituted of a plurality of portions differing in color from each other. In the present embodiment, as shown in FIGS. 8, 10, and 1 and other figures, the object is teeth 22 close to white but tinted with yellow to orange and a gum 21 tinted with red to dark red. But the object is not limited to the gum 21 and the teeth 22.

The first light source 1 emits, for example, white light such as represented by a spectrum SP1 in FIG. 2.

The second light source 2 emits, for example, light such as represented by a spectrum SP2 in FIG. 2, i.e., narrow-band light of a different color than that of light emitted from the first light source 1, having (at least one) peak (intensity peak) in a band of a width smaller than the width of the spectrum SP1 of the first light source 1.

The spectrum of light emitted from the second light source 2 is determined, for example, on the basis of a principle described below.

A method of determining the emission spectrum of the second light source 2 will be described first with reference to FIG. 3. In FIG. 3 and also in FIGS. 4 to 6, no numeric values are indicated along the abscissa and ordinate. However, FIGS. 3 to 6 are assumed to conform to the same system as that of FIG. 2.

In illuminating an object having a plurality of portions differing in color from each other so that each portion has a more desirable color, it is desirable to illuminate a portion other than a particular portion of the object (for example, with white light) so that the portion other than the particular portion has a proper color and to illuminate the particular portion in a color definitely different from that of the portion other than the particular portion (that is, in a state where the color contrast is high). A state where the color contrast is high means, specifically speaking, that a color difference between the particular portion and the portion other than the particular portion is large. Therefore, the emission spectrum of the second light source 2 is determined from the viewpoint of clarifying a hue specific to the particular portion while the influence on the hue of the portion other than the particular portion is limited.

A reflection spectrum of the object is assumed to be, for example, as shown in FIG. 3 in which RSP1 denotes a reflection spectrum (spectral reflectance) of the portion other than the particular portion and RSP2 denotes a reflection spectrum (spectral reflectance) of the particular portion. In the example shown in FIG. 3, the portion other than the particular portion has such a characteristic as to reflect light with wavelengths in a wide band, while the particular portion has such a characteristic as to reflect light with wavelengths in a narrow band on the shorter-wavelength side. In comparison between these reflection spectrums, the reflection spectrum RSP2 of the particular portion has a higher intensity value in comparison with the reflection spectrum RSP1 of the portion other than the particular portion in the vicinity of its peak.

Therefore, if light emitted from the second light source 2 has an intensity peak in a band in which the spectral reflectance of the particular portion of the object has an intensity value higher than that of the spectral reflectance of the portion other than the particular portion (the portion belonging to the area illuminated by the first illumination section 8 and different from the particular portion), the color difference between the particular portion and the portion other than the particular portion can be increased. In such a case, from the viewpoint of efficiently increasing the color difference between the particular portion and the portion other than the particular portion, it is preferred that the intensity peak of light emitted from the second light source 2 be set in the vicinity of the wavelength at which the difference between the spectral reflectance of the particular portion of the object and the spectral reflectance of the above-described portion other than the particular portion is maximized.

The emission spectrum SP2 of the second light source 2 shown in FIG. 3 is an example of such a case. SP1 denotes the emission spectrum of the first light source 1.

Increasing the color difference between the particular portion and the portion other than the particular portion as described above can be performed more efficiently if the emission spectrum of the second light source 2 can be set outside the band of the reflection spectrum of the portion other than the particular portion of the object. FIG. 4 shows an example of such a case.

In the example shown in FIG. 4, bands in which the reflection spectrum RSP2 of the particular portion and the reflection spectrum RSP1 of the portion other than the particular portion have effective intensity values are separate from each other. That is, in a band in which the reflection spectrum RSP2 of the particular portion has an effective intensity value, the intensity value of the reflection spectrum RSP1 of the portion other than the particular portion is substantially zero. In the case where the spectral reflectance characteristics of the object are such as those in the example shown in FIG. 4, the color difference can be efficiently increased by setting the emission spectrum SP2 of the second light source 2 in the band of the reflection spectrum RSP2 of the particular portion outside the band of the reflection spectrum RSP1 of the portion other than the particular portion. This is because light emitted from the second light source 2 is reflected from the particular portion but is not reflected from the portion other than the particular portion. In doing so, it is preferred that the intensity peak of light emitted from the second light source 2 be set in the vicinity of the wavelength at which the spectral reflectance of the particular portion of the object is maximized, as in the above-described case.

Next, FIG. 5 shows an example of setting of the emission spectrum of the second light source 2 in a case where the object is the gum 21 and the teeth 22, and where the particular portion is the teeth 22 while the portion other than the particular portion is the gum 21 (i.e., a case mainly described in the description of the present embodiment).

The teeth 22 as the particular portion have a white color tinted with yellow to orange, as mentioned above, but also has reflected light intensity in a blue band of shorter wavelengths, as can be understood from the spectral-reflectance spectrum RSP2 shown in FIG. 5. On the other hand, the gum 21 as the portion other than the particular portion has reflected light intensity mainly in a red band of longer wavelengths as schematically shown in the spectral-reflectance spectrum RSP1 in FIG. 5.

The spectrum of light emitted from the second light source 2 may be set so as to have an intensity peak in a wavelength band in which the value of the spectral reflectance of the teeth 22 is higher than the value of the spectral reflectance of the gum 21. If the object has spectral reflectance such as shown in FIG. 5, the value of the spectral reflectance of the teeth 22 is higher than the value of the spectral reflectance of the gum 21 in the entire visible light region and, therefore, the emission spectrum of the second light source 2 can be set in an arbitrary band in theory. From the viewpoint of efficiently increasing the color difference between the teeth 22 as the particular portion and the gum 21 as the portion other than the particular portion, however, it is preferable to set the emission spectrum of the second light source 2 outside the spectral reflectance wavelength band of the gum 21. FIG. 5 shows an example of such a preferable setting. That is, the light emitted from the second light source 2 may be set as a blue narrow-band light as represented by the spectrum SP2 in FIG. 5 or, more specifically, in terms of numeric value, as represented by the spectrum SP2 in FIG. 2.

The object is not limited to the gum 21 and the teeth 22, as mentioned above (that is, the range of application of the technique according to the present embodiment is not limited to tooth observation). FIG. 6 shows an example of setting of the reflection spectrum of the second light source 2 when the band of the reflection spectrum of the particular portion of the object is on the longer-wavelength side than the band of the reflection spectrum of the portion other than the particular portion.

In the example shown in FIG. 6, if the band of the reflection spectrum RSP1 of the portion other than the particular portion is, for example, a band from green to blue, the band of the reflection spectrum RSP2 of the particular portion is, for example, a red band on the longer-wavelength side. Further, in the example shown in FIG. 6, a band in which the reflection spectrum RSP2 of the particular portion has an effective intensity value and a band in which the reflection spectrum RSP1 of the portion other than the particular portion has an effective intensity value are separate from each other.

If the object is such as shown in FIG. 6, light emitted from the second light source 2 may be set so as to have a band outside the band of the reflection spectrum RSP1 of the portion other than the particular portion (that is, it is not necessary that the entire light emitted from the second light source 2 be outside the band of the reflection spectrum RSP1) (but it is preferable that the entire light emitted from the second light source 2 be outside the band of the reflection spectrum RSP1), and so as to have an intensity peak at the wavelength point at which the intensity value of the reflection spectrum RSP2 of the particular portion is maximized.

The configuration will be further described by referring again to FIG. 1.

The first optical system 3 is for applying white light emitted from the first light source 1 with a first directional characteristic such as represented by a curve OR1 in FIG. 7.

The second optical system 4 is for applying narrow-band light emitted from the second light source 2 with such a second directional characteristic that the light is applied to a second application area contained in a first application area based on the above-mentioned first directional characteristic. More specifically, the second directional characteristic is a directional characteristic as represented by a curve OR2 in FIG. 7, with which light is applied so as to define a spot diameter smaller than the spot diameter defined with the first directional characteristic. The spot diameter may be grasped as an area in which a brightness intensity equal to or higher than a predetermined value is obtained.

The illumination control section 5 supplies electric power to the first light source 1 and the second light source 2 and makes the first light source 1 and the second light source 2 emit light under its control.

The image pickup unit 6 is for photographing an object illuminated with the above-described illumination device to obtain an image signal. That is, the image pickup unit 6 is configured by being provided with an image pickup optical system and an image pickup device. An optical image of the object is formed on the image pickup device by the image pickup optical system. The image pickup device performs photoelectric conversion of the optical image to output the image as an image signal.

The image pickup unit control section 7 is a section for controlling the image pickup unit 6 so that the image pickup unit picks up images and obtains the image signal.

Illumination of the object with the illumination device will next be described with reference to FIGS. 8 to 10.

The teeth 22 and the gum 21 as the object have shapes such as shown in FIG. 8 when viewed from the image pickup unit 6 side.

This object is illuminated with a white illumination spot in the first application area 11 and with a narrow-band illumination spot in the second application area 12, such as shown in FIG. 9, by using the first illumination section 8 and the second illumination section 9. The first illumination section 8 and the second illumination section 9 perform illumination so that the second application area 12 is contained in the first application area 11 at the position of the object.

FIG. 10 shows the state of the object illuminated with such illumination spots.

Both white light and narrow-band light are applied to the target tooth 22, that is, a color mixing region (additive color mixing region) is defined thereon. On the other hand, the teeth 22 other than the target tooth 22 and the gum 21 are illuminated with white light. At this time, the amount of application of light having the blue band is larger in the additive color mixing region than in other regions. Since the spectral reflectance of the teeth 22 in the blue band is higher than that of the gum 21, the quantity of blue reflected light from the tooth 22 is larger than that from the gum 21. That is, a larger quantity of light having the band in which the spectral reflectance of the teeth 22 is higher than that of the gum 21 is reflected from the target tooth 22 in the second application area to which the narrow-band light is applied. The color difference between the target tooth 22 and the gum 21 is thus increased to improve the color contrast therebetween.

The application areas 11 and 12 are substantially circular according to the above description. Needless to say, the shapes of the application areas 11 and 12 may not be limited to the generally circular shapes. For example, both white light and narrow-band light may be applied to the other teeth 22 as well as to the target tooth 22 by forming the narrow-band-light application area 12 into the shape of a rectangle whose longer sides are horizontal (or the shape of an ellipse whose major axis is horizontal) while maintaining the circular shape of the white-light application area 11.

While the description has been made by assuming that the light applied by the second illumination section 9 is narrow-band light, the light applied by the second illumination section 9 is not limited to narrow-band light. For example, the light applied by the second illumination section 9 may be broad-band light or the like having such a color as to enhance the color of the particular portion of the object (that is, as to have substantially the same hue as that of the particular portion of the object and increase the chroma of the particular portion).

While only one second illumination section 9 is provided according to the above description, a plurality of illumination sections for applying light of colors different from white light may of course be provided according to the number of colors of portions constituting the object and other factors.

According to Embodiment 1 thus arranged, an object can be illuminated so that the color contrast between a particular portion of the object and a portion other than the particular portion is improved. As a result, an object having a plurality of portions differing in color from each other can be illuminated so that each portion has a more desirable color.

### Embodiment 2

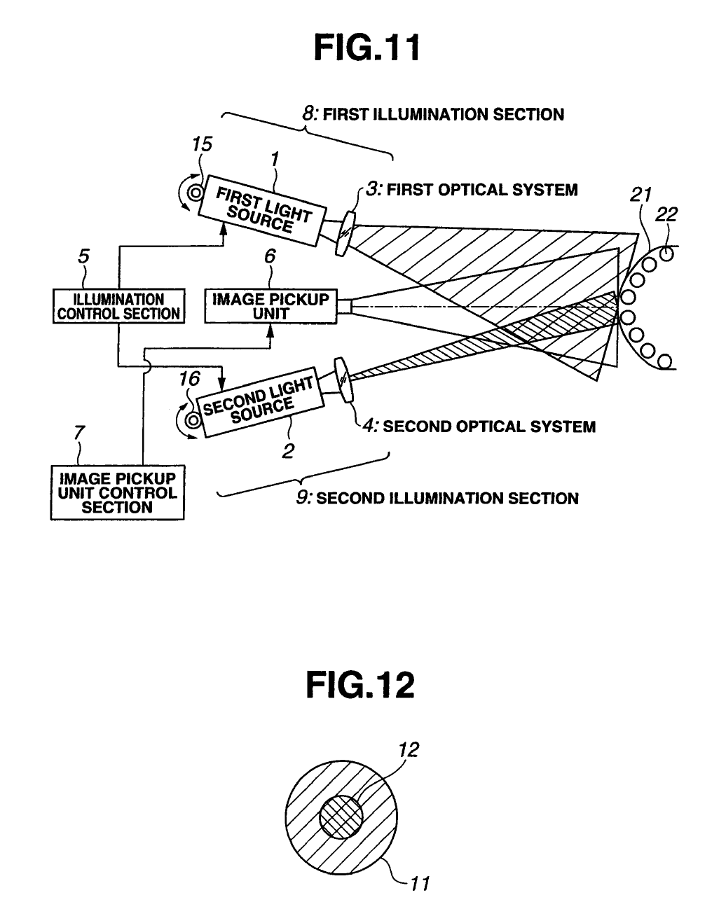

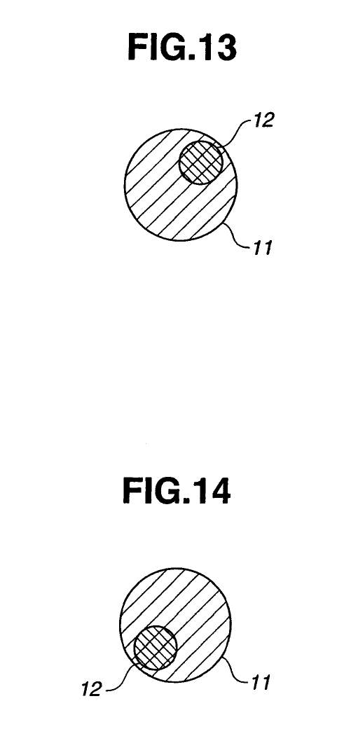

FIGS. 11 to 14 show Embodiment 2 of the present invention. FIG. 11 is a diagram showing a configuration of an image acquisition apparatus having an illumination device and an image pickup apparatus. FIG. 12 is a diagram showing a state in which a second application area is positioned at a center of a first application area. FIG. 13 is a diagram showing a state in which the second application area is positioned in an upper right portion of the first application area. FIG. 14 is a diagram showing a state in which the second application area is positioned in a lower left portion of the first application area.

In Embodiment 2, the same portions as those in the above-described Embodiment 1 are indicated by the same reference numerals and the description of the same portions is not repeated. Description will be made mainly of points of difference from Embodiment 1.

In Embodiment 2, the first illumination section 8 and the second illumination section 9 are made movable to enable the direction of application with the first directional characteristic and the direction of application with the second directional characteristic to be relatively changed.

That is, the first illumination section 8 is provided with an illumination moving portion 15 for changing the direction of application with the first directional characteristic, and the second illumination section 9 is provided with an illumination moving portion 16 for changing the direction of application with the second directional characteristic. Each of the illumination moving portions 15 and 16 may be a manual moving portion constituted of a ball joint, a hinge or the like, or an electrically operated moving portion for changing the direction of application on the basis of drive force from a drive source.

By using such illumination moving portions 15 and 16, the position of the second application area 12 forming a color mixing region in the first application area 11 can be freely changed, as shown in FIGS. 12 to 14.

According to the above description, illumination moving portions are provided in both the first illumination section 8 and the second illumination section 9 to enable the first illumination section 8 and the second illumination section 9 to respectively change the directions of application independently of each other. However, this arrangement is not exclusively used. For example, an illumination moving portion may be provided in only one of the first illumination section 8 and the second illumination section 9. Even in such a case, the directions of application can be relatively changed and changing the direction of the entire illumination device (or the entire image acquisition apparatus) suffices for making an absolute change in the directions of application.

According to Embodiment 2 thus arranged, substantially the same advantage as that of Embodiment 1 described above is obtained and the position of the second application area in the first application area can be freely changed to enable optimum illumination according to the distributions of a plurality of colors constituting the object.

### Embodiment 3

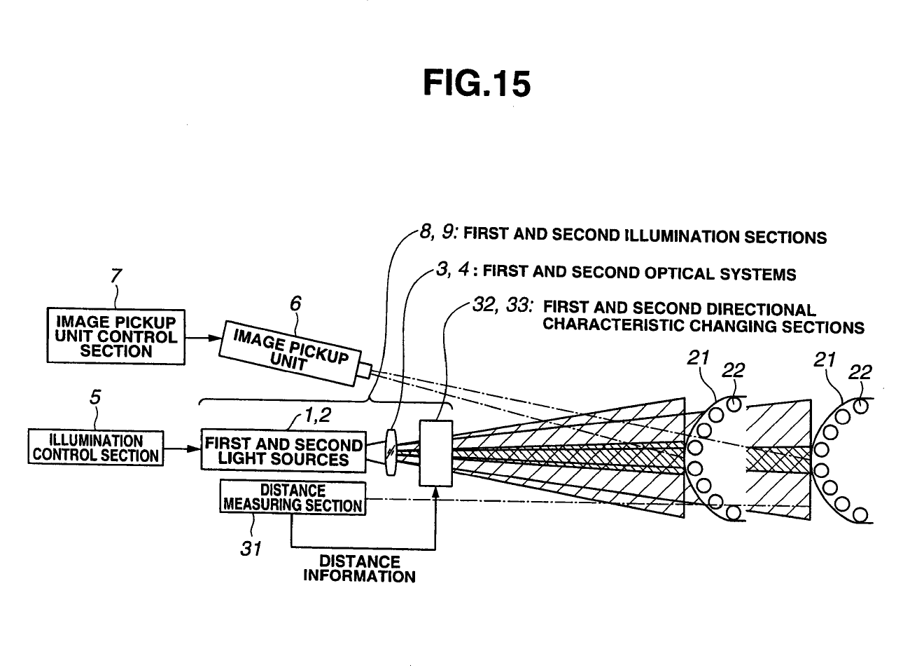

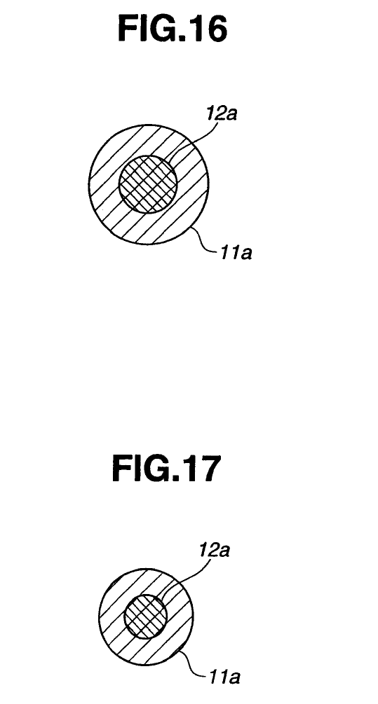

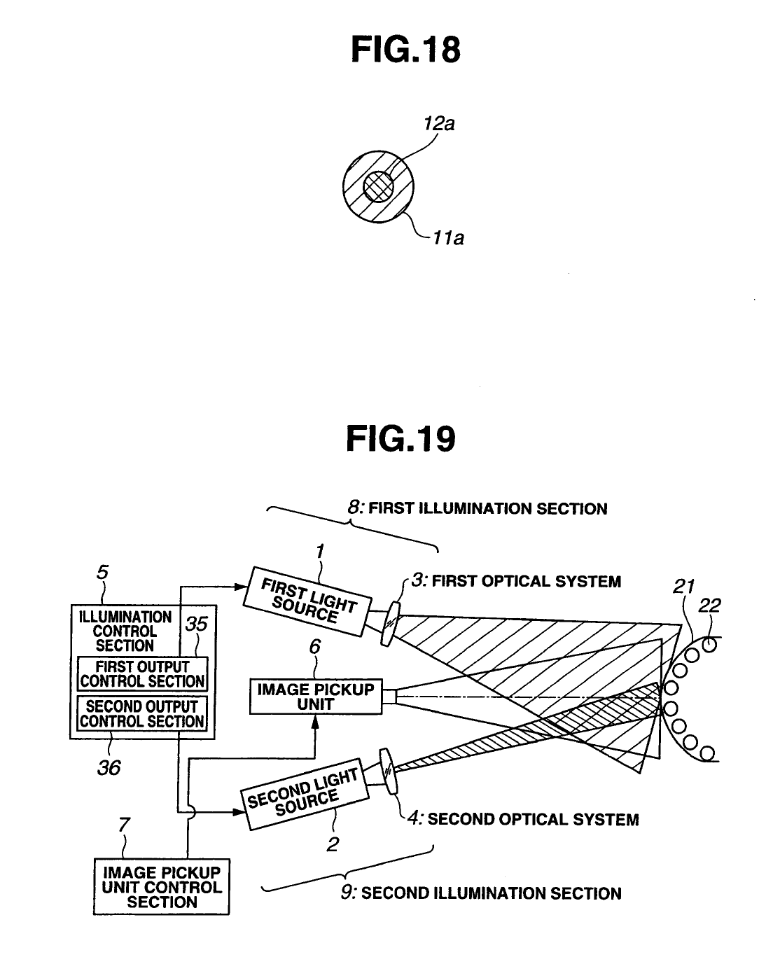

FIGS. 15 to 18 show Embodiment 3 of the present invention. FIG. 15 is a diagram showing a configuration of an image acquisition apparatus having an illumination device and an image pickup apparatus. FIG. 16 is a diagram schematically showing the states of directional characteristics of a first illumination section and a second illumination section when an object is at a short distance from the illumination device. FIG. 17 is a diagram schematically showing the states of the directional characteristics of the first illumination section and the second illumination section when the object is at a medium distance from the illumination device. FIG. 18 is a diagram schematically showing the states of the directional characteristics of the first illumination section and the second illumination section when the object is at a long distance from the illumination device.

In Embodiment 3, the same portions as those in the above-described Embodiments 1 and 2 are indicated by the same reference numerals and the description of the same portions is not repeated. Description will be made mainly of points of difference from Embodiments 1 and 2.

In Embodiment 3, first and second directional characteristic changing sections 32 and 33 are respectively provided in the first illumination section 8 and the second illumination section 9 to enable substantially the same illumination even when the distance from the illumination device to an object is changed.

That is, the first directional characteristic changing section 32 is provided in the optical path for white light applied from the first light source 1, and the second directional characteristic changing section 33 is provided in the optical path for narrow-band light applied from the second light source 2. In the example shown in FIG. 15, the first directional characteristic changing section 32 and the second directional characteristic changing section 33 are configured, for example, as zooming optical systems.

The illumination device in the present embodiment has a distance measuring section 31 to enable measurement of the distance from the first illumination section 8 and the second illumination section 9 to an object.

The distance information obtained by measurement with the distance measuring section 31 is transmitted to the first and second directional characteristic changing sections 32 and 33.

The first and second directional characteristic changing sections 32 and 33 change the directional characteristics on that basis of the transmitted distance information so that substantially the same application range of illumination can be performed no matter what the distance to the object, as shown in FIGS. 16 to 18.

That is, when the object is at a short distance from the illumination device, the first and second directional characteristic changing sections 32 and 33 change the directional characteristics for comparatively-wide-angle areas, as represented by a first application angle area 11a and a second application angle area 12a in FIG. 16.

When the object is at a medium distance from the illumination device, the first and second directional characteristic changing sections 32 and 33 change the directional characteristics for medium-angle areas, as represented by the first application angle area 11a and the second application angle area 12a in FIG. 17.

Further, when the object is at a long distance from the illumination device, the first and second directional characteristic changing sections 32 and 33 change the directional characteristics for comparatively-narrow-angle areas, as represented by the first application angle area 11a and the second application angle area 12a in FIG. 18.

The first and second directional characteristic changing sections 32 and 33 control the directional characteristics so that the first application areas 11 and the second application areas 12 at the position of the object according to the above-described first application angle areas 11a and second application angle area 12a are generally constant through the cases shown in FIGS. 16 to 18. More specifically, if a first subject distance is d1; half of the application angle at the first subject distance is θ1; a second subject distance is d2; and half of the application angle at the first subject distance is θ2, the directional characteristics are changed so that

d1·tan θ1=d2·tan θ2

is satisfied with respect to each of the first illumination section 8 and the second illumination section 9.

While the first directional characteristic changing section 32 and the second directional characteristic changing section 33 are respectively provided separately from each other according to the above description, the provision of only one directional characteristic changing section may suffice if illumination can be performed by means of a devised illumination optical system using, for example, a half mirror so that an optical axis for illumination by the first optical system 3 and an optical axis for illumination by the second optical system 4 coincide with each other.

According to Embodiment 3 thus arranged, substantially the same advantage as that of Embodiment 1 described above is obtained and substantially the same illumination can be performed even when the distance to the object is changed. Also, the directional characteristics are automatically changed according to the distance information obtained by the distance measuring section 31. Therefore, suitable illumination can be performed without requiring troublesome operations including a manual operation.

### Embodiment 4

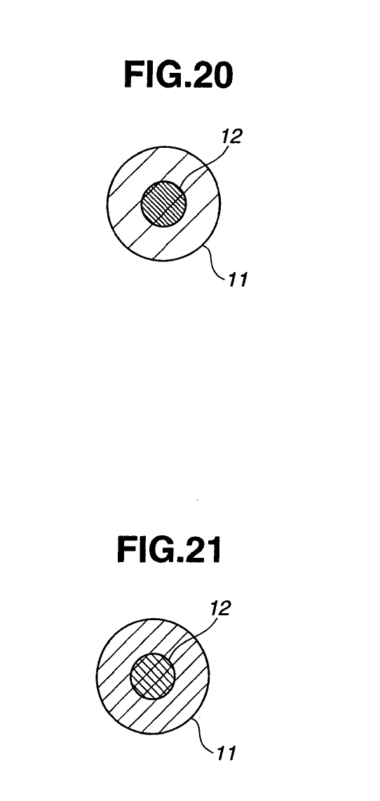

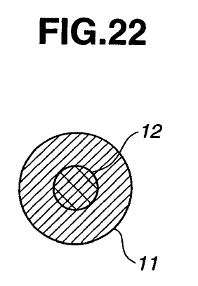

FIGS. 19 to 22 show Embodiment 4 of the present invention. FIG. 19 is a diagram showing a configuration of an image acquisition apparatus having an illumination device and an image pickup apparatus. FIG. 20 is a diagram showing the state of a color mixing region when the intensity of emission from a first light source is increased while the intensity of emission from a second light source is reduced. FIG. 21 is a diagram showing the state of the color mixing region when the intensity of emission from the first light source is set to a medium level and the intensity of emission from the second light source is also set to a medium level. FIG. 22 is a diagram showing the state of the color mixing region when the intensity of emission from the first light source is reduced while the intensity of emission from the second light source is increased.

In Embodiment 4, the same portions as those in the above-described Embodiments 1 to 3 are indicated by the same reference numerals and the description of the same portions is not repeated. Description will be made mainly of points of difference from Embodiments 1 to 3.

In Embodiment 4, the intensity of emission from the first light source 1 and the intensity of emission from the second light source 2 are respectively changed independently to enable setting a color mixing ratio in the color mixing region as desired.

That is, the illumination control section 5 is configured by being provided with a first output control section 35, which is an applied light intensity control section for controlling the intensity of light applied to an object by controlling the intensity of emission from the first light source 1, and a second output control section 36, which is an applied light intensity control section for controlling the intensity of light applied to the object by controlling the intensity of emission from the second light source 2.

The first output control section 35 and the second output control section 36 are arranged to respectively control independently the intensity of emission from the first light source 1 and the intensity of emission from the second light source 2 by controlling electric power supplied to the first light source 1 and controlling electric power supplied to the second light source 2, for example, on the basis of an input from an operation section not shown in the figure.

That is, for example, as shown in FIG. 20, the first output control section 35 controls the intensity of emission from the first light source 1 so that the emission intensity is increased, while the second output control section 36 controls the intensity of emission from the second light source 2 so that the emission intensity is reduced. In FIGS. 20 to 22, smaller hatch intervals indicate that the emission intensity is increased and, conversely, larger hatch intervals indicate that the emission intensity is reduced.

Also, for example, as shown in FIG. 21, the first output control section 35 controls the intensity of emission from the first light source 1 so that the emission intensity is at a medium level, while the second output control section 36 controls the intensity of emission from the second light source 2 so that the emission intensity is at a medium level.

Further, for example, as shown in FIG. 22, the first output control section 35 controls the intensity of emission from the first light source 1 so that the emission intensity is reduced, while the second output control section 36 controls the intensity of emission from the second light source 2 so that the emission intensity is increased.

According to the above description, the intensity of emission from the first light source 1 and the intensity of emission from the second light source 2 are respectively controlled independently. Emission intensity control, however, is not limited to this. Even with a configuration for controlling only one of the emission intensities, the color mixing ratio can be changed.

Also, according to the above description, the intensities of light applied from the first illumination section 8 and the second illumination section 9 to the object are controlled by controlling the intensities of emission from the first light source 1 and the second light source 2. Light intensity control, however, is not limited to this. For example, the intensity of applied light may be controlled by providing a transmission-type filter capable of changing the density and by controlling the density of the transmission-type filter. From the viewpoint of using a simple configuration and enabling reducing the power consumption, the method of controlling the intensities of emission from the light sources is said to be more advantageous.

According to Embodiment 4 thus arranged, substantially the same advantage as that of Embodiment 1 described above is obtained and arbitrarily changing the color mixing ratio in the color mixing region is enabled. As a result, illumination can be performed so that the particular portion of the object, e.g., the tooth 22 can have a more proper color according to whether its color is close to yellow or to orange or some other condition.

### Embodiment 5

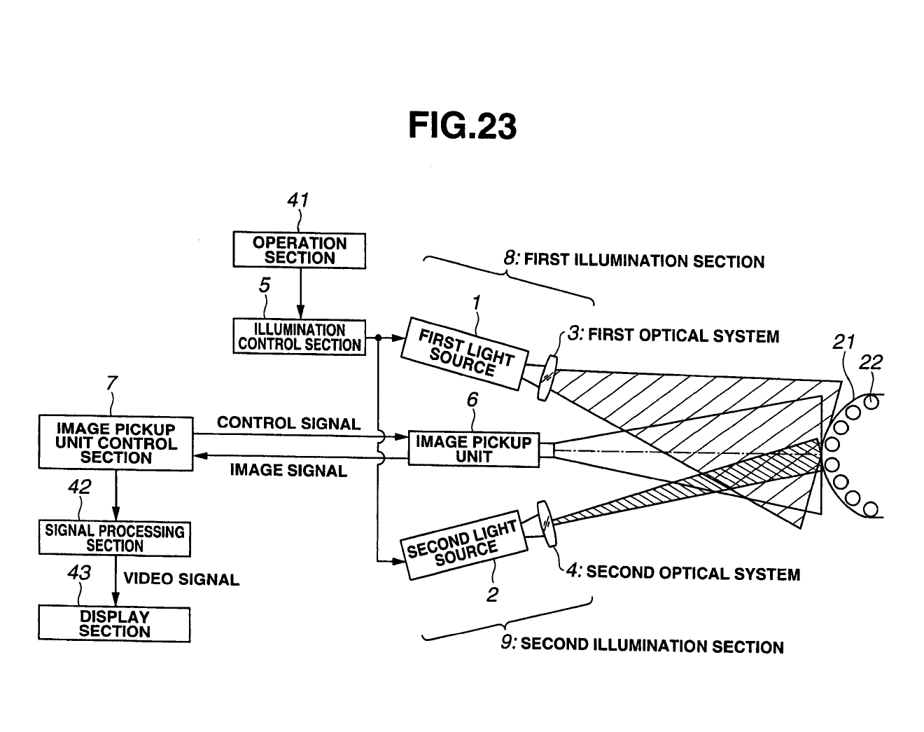

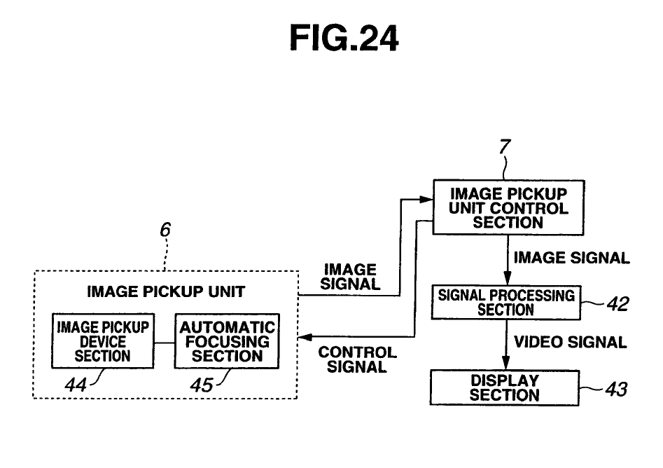

FIGS. 23 and 24 show Embodiment 5 of the present invention. FIG. 23 is a diagram showing a configuration of an image acquisition apparatus having an illumination device and an image pickup apparatus. FIG. 24 is a block diagram showing details of an image pickup unit.

In Embodiment 5, the same portions as those in the above-described Embodiments 1 to 4 are indicated by the same reference numerals and the description of the same portions is not repeated. Description will be made mainly of points of difference from Embodiments 1 to 4.

In Embodiment 5, control of illumination is performed according to an operation, the image pickup unit 6 has an automatic focusing function, and an image picked up is displayed.

That is, an operation signal is inputted from an operation section 41 to the illumination control section 5, as shown in FIG. 23. Examples of kinds of control operable through the operation section 41 are light quantity control on the light sources 1 and 2, such as that described above in the description of Embodiment 4, change of the directional characteristics, such as that described above in the description of Embodiment 3, and control of the directions of application, such as that described above in the description of Embodiment 2 (not shown in FIG. 23).

The image pickup unit 6 is configured by being provided with an image pickup device section 44 provided as an image pickup section including an image pickup device, and an automatic focusing section 45 for performing automatic focusing by focusing an image pickup optical system through which an optical image of an object is formed on the image pickup device section 44. An image signal obtained by the image pickup device section 44 (which may be either a moving image signal or a still image signal, and which is assumed here to be a moving image signal by way of example) is outputted to the image pickup unit control section 7.

The image pickup unit control section 7 is connected to a signal processing section 42 and outputs the image signal obtained from the image pickup unit 6 to the signal processing section 42.

The signal processing section 42 performs signal processing on the image signal inputted from the image pickup unit control section 7 to produce a displayable video signal, and outputs the video signal to a display section 43.

The display section 43 displays an image on the basis of the video signal from the signal processing section 42. A plurality of display sections 43 may be provided and the plurality of display sections 43 may respectively display images.

According to Embodiment 5 thus arranged, substantially the same advantage as that of Embodiment 1 described above is obtained and the provision of the automatic focusing section 45 in the image pickup unit 6 enables automatic focusing and saving working in manual adjustment or the like.

Also, since the image signal obtained by image pickup is processed by the signal processing section 42 to produce the video signal to be displayed on the display section 43, an image of the illuminated object can be observed, for example, in real time.

Since the image is displayed on the display section 43, not only a person operating the image acquisition apparatus but also other persons can observe the image. Conventionally, in the field of dentistry for example, only a dentist or the like performing a treatment on teeth can observe the progress of the treatment. For example, an intern or the like can observe only the state before the treatment and the state after the treatment. It is difficult to achieve a sufficient educational effect under such circumstances. In contrast, with the configuration according to the present embodiment, an intern or the like can observe the state of a treatment in real time and an improved educational effect can be obtained.

Further, since the operation section 41 is provided in the present embodiment, control of the first illumination section 8 and the second illumination section 9 through the illumination control section 5 can be performed even manually.

### Embodiment 6

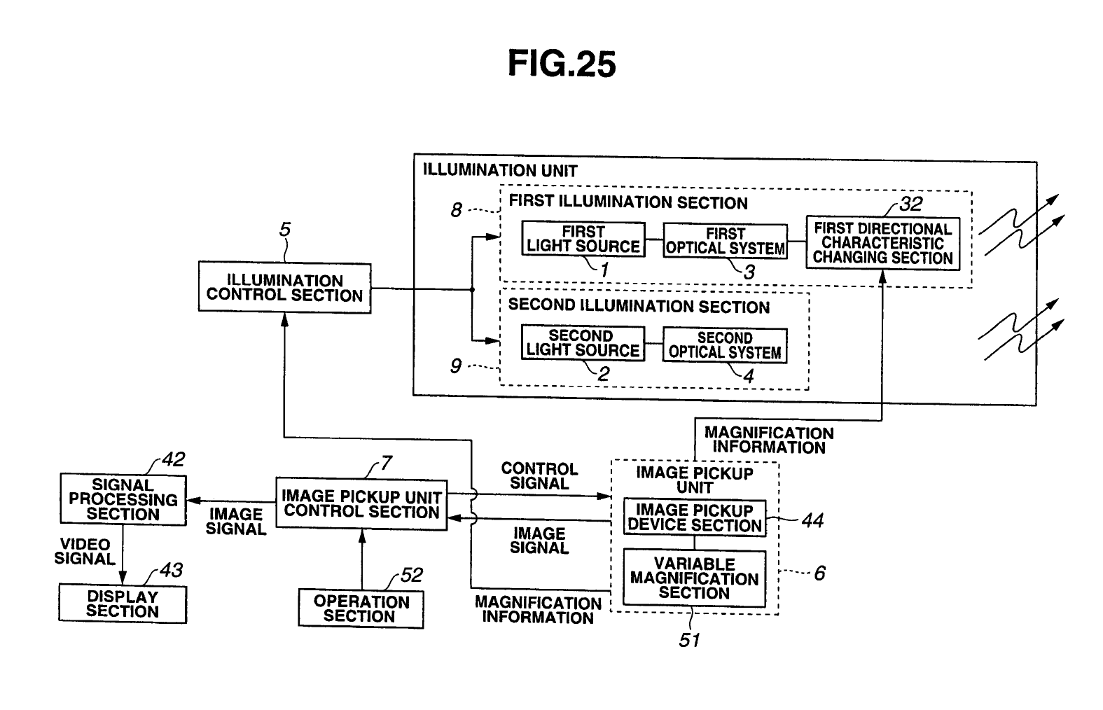

FIG. 25 shows Embodiment 6 of the present invention. FIG. 25 is a block diagram showing a configuration of an image acquisition apparatus having an illumination device and an image pickup apparatus. In Embodiment 6, the same portions as those in the above-described Embodiments 1 to 5 are indicated by the same reference numerals and the description of the same portions is not repeated. Description will be made mainly of points of difference from Embodiments 1 to 5.

In Embodiment 6, a variable magnification section 51 is provided in the image pickup unit 6 to enable control of the image pickup unit 6 to be performed according to an operation.

An illumination unit constituting the illumination device has a first illumination section 8 and a second illumination section 9, as shown in FIG. 25.

The first illumination section 8 has a first light source 1, a first optical system 3 and a first directional characteristic changing section 32.

The second illumination section 9 has a second light source 2 and a second optical system 4.

The image pickup unit 6 has an image pickup device section 44 and the variable magnification section 51. The variable magnification section 51 may be a section which changes the magnification of an optical image formed on the image pickup device section 44 (a section which changes the magnification of an optical image by controlling a variable-power optical system included in the image pickup optical system of the image pickup unit 6) or an electronic-zoom-type section which cuts a particular portion out of an image signal obtained by the image pickup device section 44 and enlarges the corresponding image portion. The image pickup unit 6 outputs magnification information to the illumination unit and to the illumination control section 5.

The image pickup unit control section 7 transmits a control signal to the image pickup unit 6 and receives an image signal from the image pickup unit 6. To the image pickup unit control section 7, an operation signal is inputted from an operation section 52. Operation inputs which can be inputted through the operation section 52 include a magnification ratio by the variable magnification section 51.

The image pickup unit control section 7 outputs the image signal received from the image pickup unit 6 to the signal processing section 42.

The signal processing section 42 converts the inputted image signal into a video signal and outputs the video signal to the display section 43.

The display section 43 displays an image on the basis of the video signal inputted from the signal processing section 42.

Next, the operation when an image is picked up while zooming is performed in the above-described configuration will be described.

For example, in a case where an image of an object subjected to image pickup is to be picked up in a certain size, zoom information is inputted from the operation section 52. At this time, the zoom information may be inputted while an image is being picked up by the image pickup unit 6 and displayed on the display section 43. In this way, the desired zoom information can be inputted while the image is being checked.

The image pickup unit control section 7 then transmits a control signal to the image pickup unit 6 on the basis of this zoom information. The variable magnification section 51 in the image pickup unit 6 receives this control signal and changes the magnification of the optical image of the object formed on the image pickup device section 44 (or cuts out a portion of the image obtained from the image pickup device section 44 and outputs the image portion as an image signal).

Magnification information indicating the change in magnification of the optical image made by the variable magnification section 51 is then transmitted to the illumination control section 5 and to the first directional characteristic changing section 32.

The first directional characteristic changing section 32 changes, on the basis of the inputted magnification information, according to the changed image pickup area, the first directional characteristic with which illumination light is applied through the first illumination section 8. More specifically, for example, in a case where image pickup is first performed at the wide-angle end by the variable magnification section 51, the first application area 11 by the first illumination section 8 is a wide area including the image pickup area at the wide-angle end. If image pickup through a smaller angle of view is performed after performing a zoom-up operation, the first application area 11 at the wide-angle end is so excessively large in comparison with the zoomed-up image pickup area that illumination light is wasted. The first directional characteristic changing section 32 therefore changes the directional characteristic of the first illumination section 8 on the basis of the inputted magnification information so that the application area 11 is reduced to such an extent as to fittingly contain the image pickup area. That is, the first directional characteristic changing section 32 changes the first directional characteristic on the basis of the magnification information from the variable magnification section 51 so that the first application area 11 by the first illumination section 8 contains the image pickup area and is not wider than or equal to the image pickup area by a predetermined value (a value representing a predetermined tolerance).

Also, the illumination control section 5 controls electric power outputted to the first light source 1 on the basis of the inputted magnification information so that an image of the object is picked up at the same brightness even after the directional characteristic has been changed by the first directional characteristic changing section 32 (electric power outputted to the second light source 2 at this time may be constant, because the actual size of the particular portion is constant while an image of the particular portion of the object is picked up at the changed magnification when the image pickup unit 6 is zoomed, and because there is no need to change the directional characteristic of the second illumination section 9).

Control is thus performed to enable necessary minimum illumination according to zooming of the image pickup unit 6.

In the above description, a case where an image of an object is to be picked up in a certain size has been taken by way of example. Needless to say, the above-described technique can also be applied in the same way in a case where an image is to be taken in a desired size.

In other respects, the operation is the same as those in the above-described embodiments.

According to Embodiment 6 thus arranged, substantially the same advantages as those in the above-described embodiments are obtained and automatic illumination by the illumination device with a suitable directional characteristic (a necessary minimum application area) according to zoom information is enabled by performing only a zooming operation on the image pickup unit 6. Thus, an unnecessary power consumption can be reduced without requiring any troublesome operation. In particular, observation of a moving image through the display section 43 requires continuous application of illumination light unlike observation of a still image. When such moving image observation is performed, therefore, a higher effect of reducing the power consumption can be obtained.

Also, a zooming operation can be executed while an image is being picked up with the image pickup unit 6 and displayed on the display section 43. Thus, a zooming operation can be performed with improved operability while an image is being actually checked.

The present invention is not directly limited to the above-described embodiments. The present invention can be embodied in an implementation stage by modifying the components to such extents as not to depart from the gist thereof. Also, various forms of the invention can be provided by suitably combining the plurality of components disclosed in the above-described embodiments. For example, some of the entire group of components in each embodiment may be removed. Further, a suitable combination of the components belonging to some of the different embodiments may be made. Needless to say, various modifications and applications of the present embodiment may be made in the above-described ways without departing from the gist of the invention.

What is claimed is:

1. An illumination device comprising:
a first illumination section having a first light source which emits white light and a first optical system for applying, with a first directional characteristic, the white light emitted from the first light source; and
a second illumination section having a second light source which emits light of a color different from the color of the light from the first light source, and a second optical system for applying the light emitted from the second light source with a second directional characteristic such that the light is applied to a second application area contained in and smaller than a first application area based on the first directional characteristic.

2. The illumination device according to claim 1, further comprising an illumination moving portion for changing at least one of a direction of application with the first directional characteristic and a direction of application with the second directional characteristic.

3. The illumination device according to claim 1, further comprising:
a distance measuring section for measuring a distance from the first illumination section and the second illumination section to an object to be illuminated; and
a directional characteristic changing section which changes the first directional characteristic and the second directional characteristic on the basis of distance information measured with the distance measuring section so that the first application area and the second application area are constant regardless of the distance from the first illumination section and the second illumination section to the object.

4. The illumination device according to claim 1, further comprising an applied light intensity control section for controlling at least one of an intensity of the light applied from the first illumination section and an intensity of the light applied from the second illumination section.

5. The illumination device according to claim 1, wherein the light applied from the second illumination section is light having an intensity peak in a band in which a spectral reflectance of a particular portion of an object to be illuminated is higher than a spectral reflectance of a portion of the object other than the particular portion and belonging to the first application area.

6. An image acquisition apparatus comprising:
the illumination device according to claim 1; and
an image pickup apparatus for obtaining an image signal by picking up an image of an object illuminated with the illumination device.

7. The image acquisition apparatus according to claim 6, wherein the illumination device further has an illumination moving portion for changing at least one of a direction of application with the first directional characteristic and a direction of application with the second directional characteristic.

8. The image acquisition apparatus according to claim 6, wherein the illumination device further has:
a distance measuring section for measuring a distance from the first illumination section and the second illumination section to an object to be illuminated; and
a directional characteristic changing section which changes the first directional characteristic and the second directional characteristic on the basis of distance information measured with the distance measuring section so that the first application area and the second application area are constant regardless of the distance from the first illumination section and the second illumination section to the object.

9. The image acquisition apparatus according to claim 6, wherein the illumination device further has an applied light intensity control section for controlling at least one of an intensity of the light applied from the first illumination section and an intensity of the light applied from the second illumination section.

10. The image acquisition apparatus according to claim 6, wherein the illumination device is configured so that the light applied from the second illumination section has an intensity peak in a band in which a spectral reflectance of a particular portion of an object to be illuminated is higher than a spectral reflectance of a portion of the object other than the particular portion and belonging to the first application area.

11. The image acquisition apparatus according to claim 6, wherein the image pickup apparatus has an image pickup section for converting an optical image into an image signal, and an automatic focusing section for automatically focusing an optical image formed on the image pickup section.

12. The image acquisition apparatus according to claim 6, further comprising:
a signal processing section which performs signal processing on an image signal obtained by the image pickup apparatus to produce a displayable video signal; and
a display section which displays the video signal produced by the signal processing.

13. The image acquisition apparatus according to claim 6, wherein the image pickup apparatus has a variable magnification section which changes an image pickup area through which an image is picked up, and outputs magnification information according to the changed image pickup area, and wherein the illumination device further has a directional characteristic changing section which changes the first directional characteristic on the basis of magnification information from the variable magnification section so that the first application area from the first illumination section contains the image pickup area and is not wider than the image pickup area by a predetermined value.
